(19) United States
(12) Patent Application Publication
(10) Pub. No.: US 2016/0331158 A1
(43) Pub. Date: Nov. 17, 2016

(54) Object hanger hook with friction-increasing compression

(71) Applicant: Mark Robert Leahy, Seattle, WA (US)

(72) Inventor: Mark Robert Leahy, Seattle, WA (US)

(21) Appl. No.: 14/709,960

(22) Filed: May 12, 2015

(51) Int. Cl. A47G 1/16; F16M 13/02

(52) U.S. Cl. CPC A47G 1/1613; F16M 13/02

(57) ABSTRACT

An object hanger hook for hanging an item, such as a picture, to a vertical or near vertical wall surface utilizing elements that provide internal, generally orthogonal forces against an opposing internal hook surface that help secure and level item to be hung. Embodiments are described each showing force elements and elements to make engagement or release of object hanger hook from item to be hung easy and adjustable.

### CROSS-REFERENCE TO RELATED APPLICATIONS

This application claims the benefit of PPA application No. 61/992,058, filed May 12, 2014 by the present inventor, which is incorporated by reference.

### FEDERALLY SPONSORED RESEARCH

None; no federally sponsored research was involved in this invention

### NAMES OF PARTIES TO A JOINT RESEARCH AGREEMENT

None; no joint research agreement associated with this invention

### SEQUENCE LISTING

None and not applicable to this invention

### STATEMENT REGARDING PRIOR DISCLOSURES BY AN INVENTOR OR JOINT INVENTOR

Not applicable (i.e. no disclosures by inventor prior to PPA No. 61/992,058)

### BACKGROUND OF INVENTION

Previously, numerous devices for positioning, securing, and otherwise hanging items to a vertical or near vertical surface, typically a wall, are known in the prior art. Many efforts have been made to solve the several problems that exist when attempting to “hang something on a wall,” an often frustrating, time consuming, and surprisingly difficult task.

These problems include, but are not limited to: a) easily attaching the item to the surface via a hanger—without the need to “look behind the item or picture” in order to avoid snagging on the nail or fastener used to attach a given hanger or hook to the surface (the “don't miss the hook, and don't snag the nail either” dilemma), b) positioning the item close to where you want it visually—without the need to remove and reattach the hanger, c) maintaining the item hung to the surface in a level and pleasing position (e.g. no canting, slanting, etc.) despite occasional disruptive vibrations to the surrounding environment or in the case of imperfect placement of a picture mount or clip used in conjunction with a hanger (e.g. placement of the mount slightly off-center of the item hung or otherwise attached to the vertical surface), d) preventing unintentional disconnect from the hanger as a result of shaking, bumping, or jarring events (e.g. minor earthquake, people or objects bumping into the item hung on the surface, etc.).

A large commercial market exists for picture hooks, hanger systems, and other hanger devices. Solving the problems of what would seem to be a simple task has been a focus of several devices available on the market today.

### BRIEF SUMMARY OF THE INVENTION

Solving the problems associated with “hanging something on a wall” is accomplished significantly by providing a hanger hook (open on both ends) that includes an internal compression force element that applies pressure in a mostly orthogonal direction to the force of gravity and increases stabilizing frictional forces that are on vertical interior surfaces (opposing to the compression force element surface) of the hanger hook. This hanger hook, among other benefits, helps stabilize, prevent or limit canting due to disturbing effects of minor forces in the surrounding environment that lead to misaligned pictures and items hung on or attached to a wall or vertical surface, and prevent unintentional disconnect.

The hanger hook includes effectively recessed fastener positions as to eliminate snagging, or otherwise mistakenly hanging an item on the nail (or other type of fastener used to secure a hanger or picture hook to a vertical surface) or an inappropriate part of a picture hanger hook. The recessed fastener aspect of the hanger hook eliminates the need to “look/reach behind the object” in order to make certain that the hanger hook has been properly engaged. Some embodiments are envisioned to employ a “click” sound to indicate proper engagement of the hanger hook.

Easy removal of the item from the hanger hook is accomplished by reversing the compression force via the application of a pushing action near the hanger hook and typically toward the wall or vertical surface effectively releasing the item engaged in the hanger hook from frictional surfaces that contact the vertical interior surface of the hanger hook and then moving the item vertically or horizontally or combination of each direction sufficient to clear the hanger hook. Removal (as in engagement of the hanger hook) is accomplished without the need to look behind the picture or other type of item that is hung to a vertical or near vertical surface. Similarly, repositioning of the item being hung can be adjusted vertically or horizontally (to the limit of the physical constraints of the hanger hook) by countering the compressive force, moving the item the desired distance, then releasing and thereby engaging or allowing the compressive force to once again become effective.

### BRIEF DESCRIPTION OF THE DRAWINGS

In accordance with one embodiment FIG. 1 illustrates the hanger hook with hanger hook frame (wall leg) 10a-1, hanger hook frame (base) 10b-1, hanger hook frame (opposing leg) 10c-1, hanger hook pocket 12-1, compression element 14-1, compression element contact surface 15-1, friction element 16-1, recessed fastener holes 18-1. Compression element 14-1 illustrates of the use of materials that can be attached to the side leg 10a-1 forming hanger hook pocket 12-1 opposite to friction element 16-1. Materials chosen in this embodiment should provide the necessary elastic, compressible characteristics needed to provide sufficient orthogonal force against the hook frame (opposing leg) 10c-1 in order to secure an item inserted into hook pocket 12-1.

In accordance with another embodiment FIG. 2 illustrates the hanger hook with hanger hook frame (wall leg) 10a-2, hanger hook frame (base) 10b-2, hanger hook frame (opposing leg) 10c-2, hanger hook pocket 12-2, compression element 14-2, friction element 16-2, recessed fastener holes 18-2. Compression element 14-2 is shown as a pair of “arms” that extend into hanger hook pocket 12-2 to depict how flexible, elastic (and providing sufficient compressible force) arms can act as source of the compression force needed to create the benefits of this hanger hook.

FIG. 3 illustrates how an embodiment depicted might be employed using a matching or tuned “male” mounting clip 20-3. Mounting clip 20-3 is shown to fit suitably into the hanger hook pocket 12-3. It can be seen from FIG. 3 how a matched mounting clip and hanger hook can be engaged.

### DETAILED DESCRIPTION OF THE INVENTION

According to this invention, a hanger hook is provided with open sides, a vertical surface contacting hanger frame leg (e.g. 10a-1), an opposing hanger frame leg (e.g. 10c-1), and a connecting hanger frame base (e.g. 10b-1). Combining the hanger hook legs results in a hanger hook pocket (e.g. 12-1) that has generally right angle construction with a flat base. This generally flat base for the hanger hook pocket provides several benefits: (a) distribution of downward pressure, (b) the necessary space for compression element design and action, (c) opportunity for a customer to make subtle additions to the base and thereby raise an item being hung by the hanger hook without introducing destabilization.

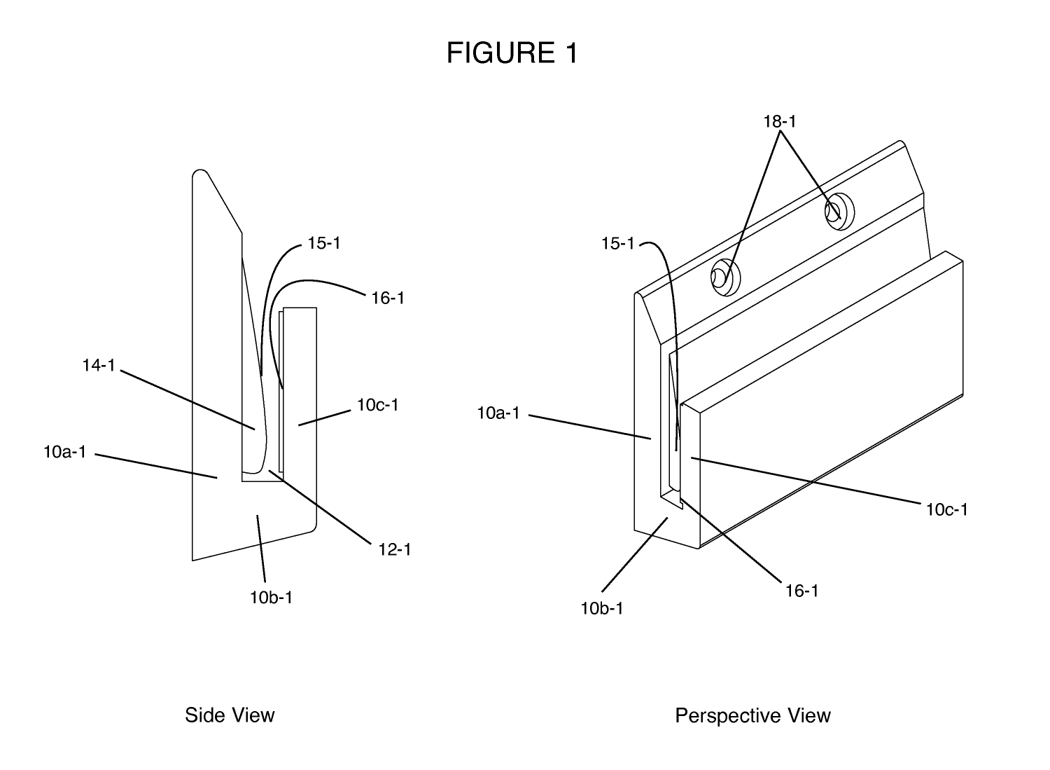

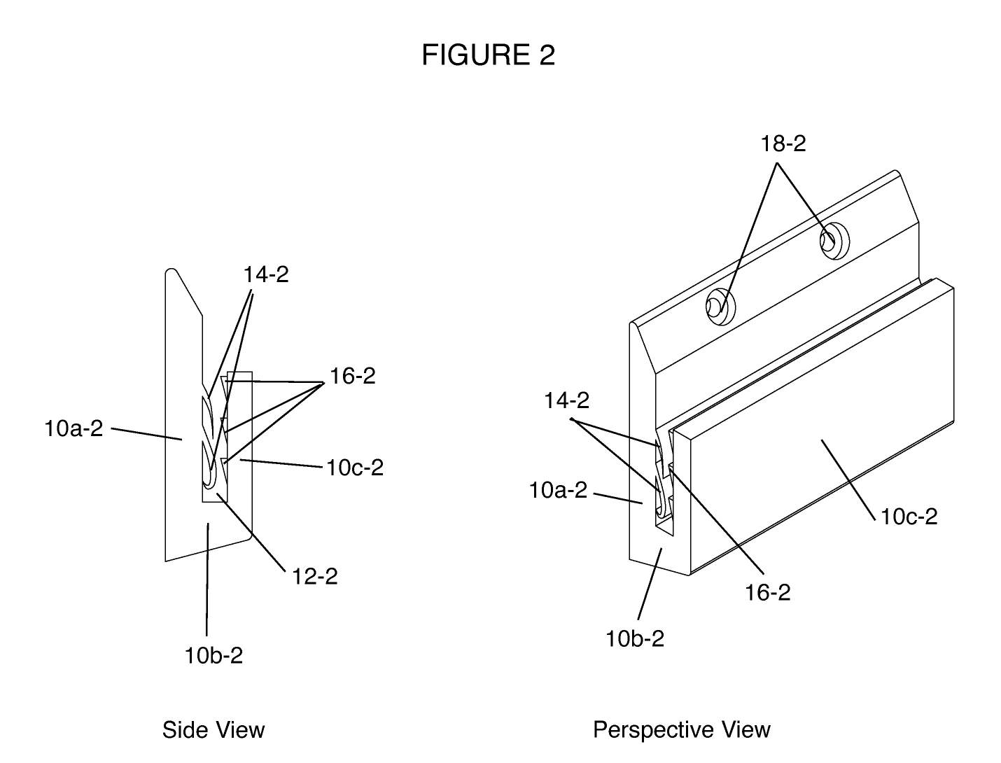

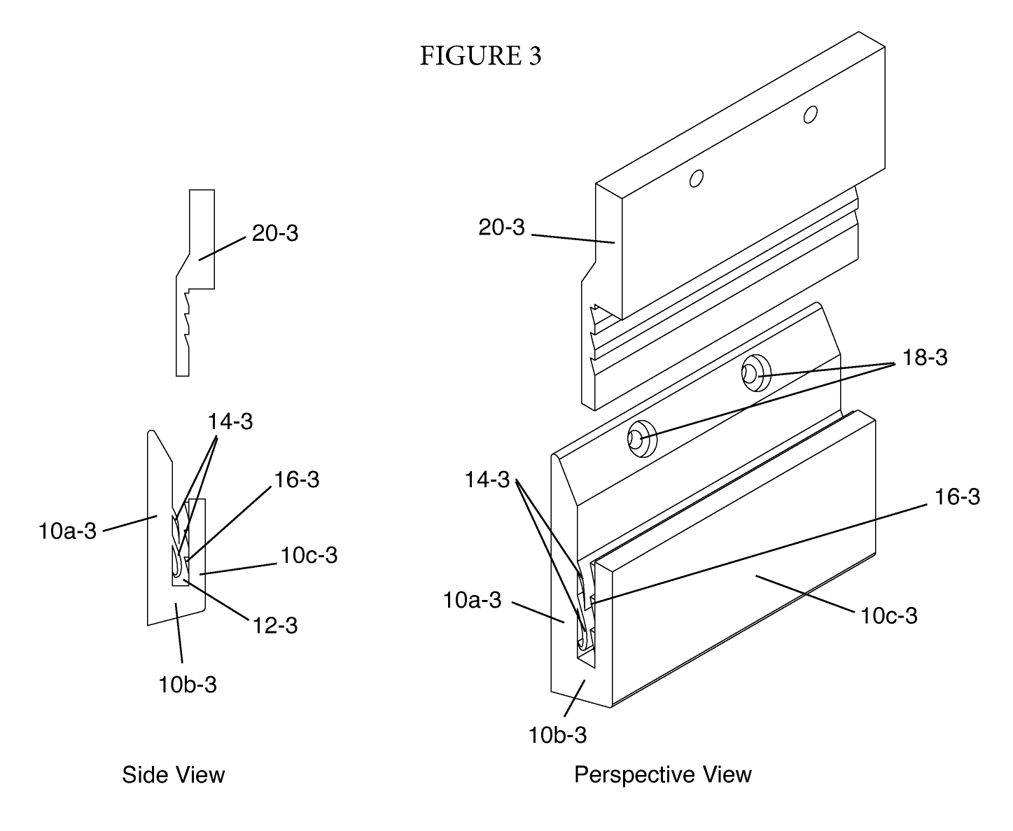

The hanger hook may be attached (e.g. nailed, screwed, or by the use of similar means) to a vertical surface utilizing the recessed fastener holes (e.g. 18-1, 18-2, 18-3). The hanger hook can have as few as one fastener hole though embodiments using more fastener holes are envisioned that would allow easier leveling of hanger hook. The sloping face (illustrated in FIG. 1) combined with recessed fastener holes guides an appropriately sized mounting clip smoothly and directly into the hanger hook pocket 12-1. It is envisioned that any appropriately sized mounting clip that is secured to the back of an item, such as a picture frame, to be hung on a wall or otherwise vertical surface would engage the hanger hook. The reader can see from FIG. 3 how the hanger hook is engaged: mounting clip 20-3 slides over a recessed fastener, compresses the compression element, and then is in the hanger hook pocket 12-3; releasing and engaging the compression force secures the clip against the vertical, inside friction element 16-3 on the opposing leg of the hanger hook frame 10c-3 thereby securing the item to be hung on a wall or vertical surface. Additionally, an embodiment illustrated in FIG. 1 depicts where the surface of the compression element can be coated with a friction-lowering compound or material (compression element contact surface 15-1). Reducing friction associated with the surface of the compression element (and focusing friction benefits to the outer, opposing hanger hook leg) can be advantageous in certain product designs for the market.

The hanger hook frame can be made out of many materials depending upon strength requirements or marketing needs for the product. These materials include, but are not limited to, metals, plastics, and composite materials. The hanger hook compression element can easily be made from a diverse set of materials known in the art—including, but not limited to, elastic metals and alloys, polymers with elastic characteristics, composite materials with elastic characteristics, springs, and opposing magnetic pole surfaces.

The hanger hook friction element (e.g. 16-1) provides many benefits, particularly when combined with the compression force applied via the compression element. FIG. 2 and FIG. 3 illustrate one embodiment that employs a frictional surface on both a “male mounting clip” and the interior vertical surface of the hook frame (opposing leg) (e.g. 10c-3). The friction element provides functional and improved stability, both laterally and vertically, to the hanger hook described here, improving on existing picture hook designs available in the market today. The friction element can be manufactured from many materials known in the art today—including but not limited to crystals or crystalline-like materials (e.g. “sandpaper”), metals, rubber and other rubber-like materials, polymers with high friction coefficients, solid or soft materials shaped in configurations to create frictional surfaces.

The reader can see accordingly, from the few embodiments described here, that the hanger hook provides many improvements and superior benefits over existing picture hanging options available today including: a) ease of engagement of a mounting clip or wire into the hanger hook, b) adjustability both laterally and vertically—a much valued benefit when arranging items on a wall for display, c) superior stability—by using orthogonal forces and added friction resulting from the employment of the interior compression force, and d) superior engagement or attachment of a mounting clip or device (attached to a picture or item to be hung on a wall) to the hanger hook by utilizing additional forces beyond that of gravity.

While the above description contains many specifications, these should not be construed as limitations on the scope of any embodiment, but as exemplifications of various embodiments thereof. Many other ramifications and variations are possible with in the teachings of the various embodiments. Thus, the scope should be determined by the appended claims and their legal equivalents, and not by the examples given.

I claim:

1. A hanger for attaching items to a vertical or near vertical surface comprising:
a. a hanger frame having two vertical planar legs connected at ends by a flat planar base at approximate right angles to the vertical planar legs,
b. a compressible element that delivers force generally orthogonal to the force of gravity and the vertical planar legs of the hanger frame,
c. a friction element attached to the vertical planar leg of the hanger opposite to the compressible element,
d. a fastener hole or holes in said hanger frame placed above the hanger frame base and through the vertical planar leg that contacts with a vertical or near vertical surface such that the fasteners used to attach said hanger to a wall, vertical or near vertical surface have their head or heads recessed and free from snagging of a mounting clip or wire used to attach a picture or item to be hung or otherwise attached to a wall or vertical or near vertical surface by the hanger.
